(19) United States
(12) Patent Application Publication
(10) Pub. No.: US 2017/0268540 A1
(43) Pub. Date: Sep. 21, 2017

(54) HYDRAULIC CONTROL SYSTEM FOR WORK MACHINE

(71) Applicant: HITACHI CONSTRUCTION MACHINERY CO., LTD., Tokyo (JP)

(72) Inventors: Hidekazu MORIKI, Mito-shi (JP); Shinya IMURA, Toride-shi (JP); Tsutomu UDAGAWA, Tsukuba-shi (JP); Ryohei YAMASHITA, Tsuchiura-shi (JP); Kouji ISHIKAWA, Kasumigaura-shi (JP)

(21) Appl. No.: 15/504,864

(22) PCT Filed: Aug. 28, 2015
(86) PCT No.: PCT/JP2015/074544

§ 371 Date: Feb. 17, 2017

(30) Foreign Application Priority Data
Nov. 6, 2014 (JP) 2014-226519

(51) Int. Cl. F15B 11/16; E02F 3/32; F15B 11/17; E02F 9/22; F15B 11/10

(52) U.S. Cl. CPC F15B 11/161; E02F 9/22; F15B 11/10; F15B 11/17; E02F 9/2271; E02F 9/2292; E02F 9/2267; E02F 3/32; F15B 2211/20576; F15B 2211/605; F15B 2211/6346; F15B 2211/455; E02F 9/0883

(57) ABSTRACT

A work machine including a specific actuator that supplies hydraulic fluid from a plurality of hydraulic pumps includes: first and second hydraulic pumps communicating with a first hydraulic actuator; a first control valve returning hydraulic fluid delivered by the first hydraulic pump to a tank; and a load detection section that detects a load on the first hydraulic actuator. A control valve drive section drives the first control valve such that a communication area between the first hydraulic pump and the tank is enlarged corresponding to an increase in the load on the first hydraulic actuator; and a flow rate control section, during supply of the hydraulic fluid from the first and second hydraulic pumps to the first hydraulic actuator, controls to reduce a delivery flow rate of the first hydraulic pump corresponding to an increase in the load on the first hydraulic actuator.

### TECHNICAL FIELD

The present invention relates to a hydraulic control system for a work machine.

### BACKGROUND ART

A known hydraulic control system is intended for a construction machine that is designed to achieve an even more increased speed of a specific actuator that can be driven through merging of hydraulic fluids from two hydraulic pumps. This construction machine includes an engine, variable displacement first and second hydraulic pumps driven by the engine, a specific actuator that can be driven through merging of the hydraulic fluid delivered from each of the first hydraulic pump and the second hydraulic pump, another actuator that is different from the specific actuator, and a third hydraulic pump that is driven by the engine to supply the hydraulic fluid for driving the another actuator. The hydraulic control system includes a merging valve that can merge the hydraulic fluid from the third hydraulic pump with the hydraulic fluid from the first hydraulic pump and the second hydraulic pump to thereby selectively supply the merged hydraulic fluid to the specific actuator and a merging cancellation valve that cancels the merging function of the merging valve (see, for example, Patent Document 1).

### PRIOR ART DOCUMENT

### Patent Document

Patent Document 1: JP-2000-337307-A

### SUMMARY OF THE INVENTION

### Problem to be Solved by the Invention

A hydraulic control circuit in the known hydraulic control system described above includes the merging cancellation valve that cancels the merging function of the merging valve. When load pressure on an arm cylinder is high, the merging cancellation valve is operated and delivery fluid of the third hydraulic pump is thereby returned from the merging valve to a tank, so that the delivery pressure of the third hydraulic pump is reduced. This reduces the load on the third hydraulic pump to thereby increase a delivery flow rate of other hydraulic pumps. As a result, a flow rate to be supplied to actuators including a bucket cylinder driven by other hydraulic pumps can be obtained, so that favorable combined operability can be achieved.

The hydraulic control circuit in the known art described above, however, has the following problem in terms of energy saving.

In general, since a leakage flow rate of a hydraulic pump increases with increasing delivery pressure, the leakage flow rate has a greater effect on total loss of the hydraulic pump at higher delivery pressure values. The merging cancellation valve is thus operated to correspond to the load pressure and the delivery pressure of the third hydraulic pump is thereby reduced. The leakage flow rate of all pumps can thereby be reduced. Unfortunately, however, the patent document of the known art does not describe flow rate control of the third hydraulic pump during this time.

Application of well-known positive control, for example, causes the third hydraulic pump to deliver a flow rate in accordance with an operation amount of an arm lever. This can increase likelihood that an inoperative flow rate representing the fluid returning to the tank without being supplied to the actuator increases. As a result, a waste of energy occurs.

The present invention has been made in view of the foregoing situation and it is an object of the present invention to provide, in a hydraulic control system for a work machine including a specific actuator to which hydraulic fluid can be supplied from a plurality of hydraulic pumps, an energy-saving hydraulic control system for a work machine.

### Means for Solving the Problem

To achieve the foregoing object, an aspect of the present invention provides a hydraulic control system for a work machine including: a first hydraulic actuator; a first hydraulic pump and a second hydraulic pump capable of communicating with the first hydraulic actuator; a first control valve capable of returning a hydraulic fluid delivered by the first hydraulic pump to a tank; and a load detection section that detects a load on the first hydraulic actuator. The hydraulic control system includes: a control valve drive section that takes in a detection signal detected by the load detection section and drives the first control valve such that a communication area between the first hydraulic pump and the tank is enlarged corresponding to an increase in the load on the first hydraulic actuator; and a flow rate control section that, during supply of the hydraulic fluid from the first hydraulic pump and the second hydraulic pump to the first hydraulic actuator, takes in a detection signal detected by the load detection section and controls to reduce a delivery flow rate of the first hydraulic pump corresponding to an increase in the load on the first hydraulic actuator.

### Effects of the Invention

In accordance with an aspect of the present invention, the delivery flow rate of the first hydraulic pump is decreased with an increasing load on the first hydraulic actuator to thereby drive the first control valve so as to enlarge the communication area between the first hydraulic pump and the tank, so that the delivery pressure of the first hydraulic pump can be reduced and a pump total leakage flow rate can be reduced. A void flow rate delivered from the first hydraulic pump can thus be reduced. As a result, an energy-saving hydraulic control system for a work machine can be provided.

### BRIEF DESCRIPTION OF THE DRAWINGS

FIG. 1 is a perspective view of a work machine that includes a hydraulic control system for a work machine according to a first embodiment of the present invention.

FIG. 2 is a hydraulic control circuit diagram of the hydraulic control system for a work machine according to the first embodiment.

FIG. 3 is a conceptual diagram of a configuration of a controller that constitutes the hydraulic control system for a work machine according to the first embodiment.

FIG. 4 is a characteristic diagram representing an exemplary map used for arithmetic operations performed by a target operation arithmetic section of the controller that constitutes the hydraulic control system for a work machine according to the first embodiment.

FIG. 5 is a control block diagram representing exemplary arithmetic operations performed by a communication control section of the controller that constitutes the hydraulic control system for a work machine according to the first embodiment.

FIG. 6 is a conceptual diagram of a configuration of a flow rate control section of the controller that constitutes the hydraulic control system for a work machine according to the first embodiment.

FIG. 7 is a control block diagram representing exemplary arithmetic operations performed by a boom flow rate allocation arithmetic section of the controller that constitutes the hydraulic control system for a work machine according to the first embodiment.

FIG. 8 is a control block diagram representing exemplary arithmetic operations performed by an arm target flow rate allocation arithmetic section of the controller that constitutes the hydraulic control system for a work machine according to the first embodiment.

FIG. 9 is a control block diagram representing exemplary arithmetic operations performed by a pump flow rate command arithmetic section of the controller that constitutes the hydraulic control system for a work machine according to the first embodiment.

FIG. 10 is a characteristic diagram representing an exemplary map used for arithmetic operations performed by an arm flow rate allocation arithmetic section of the controller that constitutes the hydraulic control system for a work machine according to the first embodiment.

FIGS. 11(a) to 11(e) are characteristic diagrams illustrating exemplary operations relating to a pump flow rate control section in the hydraulic control system for a work machine according to the first embodiment.

FIG. 12 is a hydraulic control circuit diagram of a hydraulic control system for a work machine according to a second embodiment.

### MODES FOR CARRYING OUT THE INVENTION

A hydraulic control system for a work machine according to embodiments is described below with reference to the accompanying drawings.

### First Embodiment

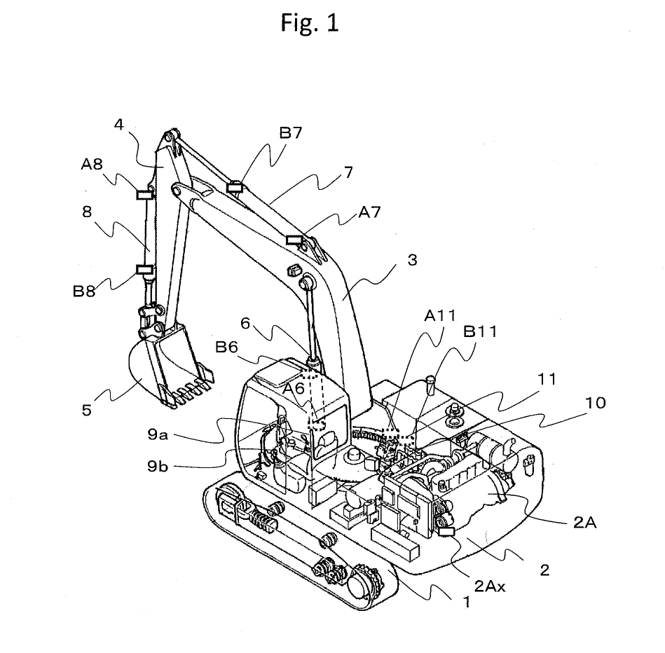

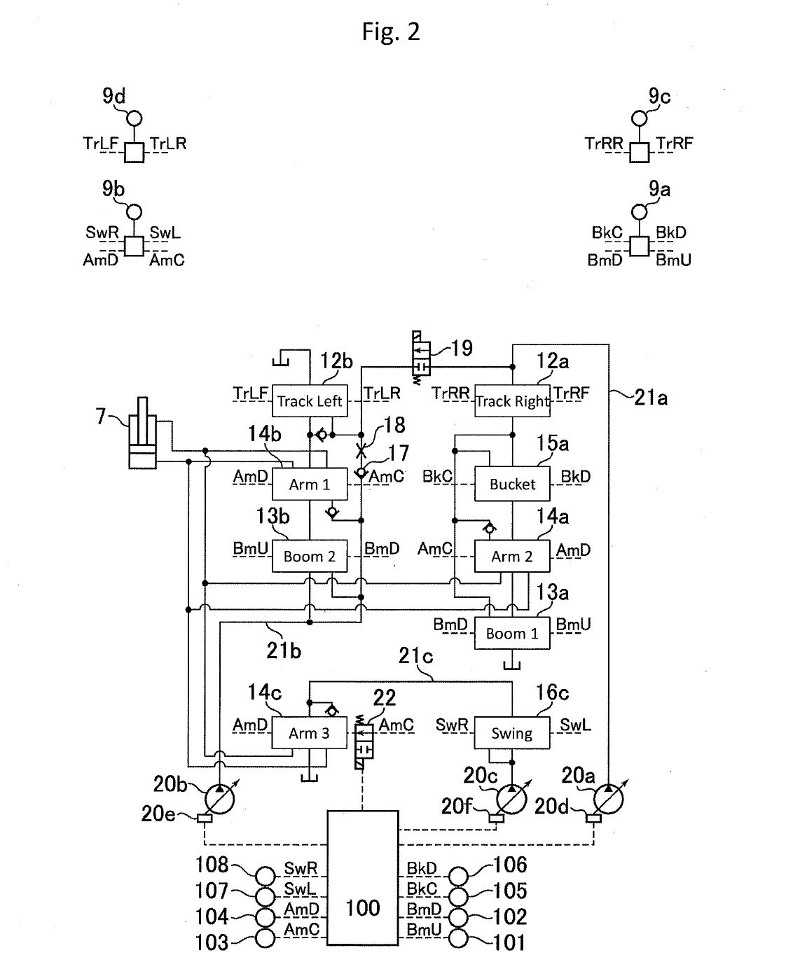

FIG. 1 is a perspective view of a work machine that includes a hydraulic control system for a work machine according to a first embodiment of the present invention. FIG. 2 is a hydraulic control circuit diagram of the hydraulic control system for a work machine according to the first embodiment.

As shown in FIG. 1, a hydraulic excavator that includes the hydraulic control system for a work machine according to the first embodiment includes a lower track structure 1, an upper swing structure 2 disposed on the lower track structure 1, a front work implement connected to the upper swing structure 2 rotatably in a vertical direction, and an engine 2A as a prime mover. The front work implement includes a boom 3, an arm 4, and a bucket 5. Specifically, the boom 3 is installed to the upper swing structure 2. The arm 4 is installed to a distal end of the boom 3. The bucket 5 is installed to a distal end of the arm 4. In addition, the front work implement includes a pair of boom cylinders 6, an arm cylinder 7, and a bucket cylinder 8. Specifically, the boom cylinders 6 drive the boom 3. The arm cylinder 7 drives the arm 4. The bucket cylinder 8 drives the bucket 5.

The hydraulic excavator supplies hydraulic fluid delivered by a hydraulic pump unit not shown to the boom cylinders 6, the arm cylinder 7, the bucket cylinder 8, and a swing hydraulic motor 11 via a control valve 10 in accordance with an operation of a first control lever 9a or a second control lever 9b provided in a cabin of the upper swing structure 1. A cylinder rod of each of the boom cylinders 6, the arm cylinder 7, and the bucket cylinder 8 is extended and contracted by the hydraulic fluid, so that a position and posture of the bucket 5 can be varied. Additionally, the swing hydraulic motor 11 is rotated by the hydraulic fluid, so that the upper swing structure 2 swings with respect to the lower track structure 1.

The control valve 10 includes a track right directional control valve 12a, a track left directional control valve 12b, a boom first directional control valve 13a, a boom second directional control valve 13b, an arm first directional control valve 14b, an arm second directional control valve 14a, an arm third directional control valve 14c, a bucket directional control valve 15a, and a swing directional control valve 16c to be described later.

The engine 2A includes a speed sensor 2Ax that detects an engine speed. The boom cylinders 6 each include a pressure sensor A6 that detects pressure of a bottom-side fluid chamber and a pressure sensor B6 that detects pressure of a rod-side fluid chamber. The arm cylinder 7 includes a pressure sensor A7 that detects pressure of a bottom-side fluid chamber as a load acquisition part and a pressure sensor B7 that detects pressure of a rod-side fluid chamber. Similarly, the bucket cylinder 8 includes a pressure sensor A8 that detects pressure of a bottom-side fluid chamber and a pressure sensor B8 that detects pressure of a rod-side fluid chamber. The swing hydraulic motor 11 includes pressure sensors A11 and B11 that detect clockwise and counterclockwise swing pressures. Pressure signals detected by the pressure sensors A6 to A8, B6 to B8, A11, and B11 and the engine speed detected by the speed sensor 2Ax are applied to a controller 100 to be described later.

A pump system 20 that constitutes the hydraulic control system for a work machine according to the first embodiment includes, as shown in FIG. 2, a first hydraulic pump 20a, a second hydraulic pump 20b, and a third hydraulic pump 20c that are variable displacement type hydraulic pumps. The first to third hydraulic pumps 20a to 20c are driven by the engine 2A.

The first hydraulic pump 20a includes a regulator 20d that is driven by a command signal from the controller 100 to be described later and supplies a first pump line 21a with a controlled delivery flow rate of the hydraulic fluid. Similarly, the second hydraulic pump 20b includes a regulator 20e that is driven by a command signal from the controller 100 to be described later and supplies a second pump line 21b with a controlled delivery flow rate of the hydraulic fluid. Additionally, the third hydraulic pump 20c includes a regulator 20f that is driven by a command signal from the controller 100 to be described later and supplies a third pump line 21c with a controlled delivery flow rate of the hydraulic fluid.

For a simplified description, descriptions for, for example, relief valves, return circuits, and load check valves that are not directly connected with the present embodiment are omitted. Additionally, the present embodiment will be described for a case in which the present invention is applied to a well-known open center type hydraulic control system. The application is, however, illustrative only and not limiting.

The track right directional control valve 12a, the bucket directional control valve 15a, the arm second directional control valve 14a, and the boom first directional control valve 13a are disposed in the first pump line 21a that communicates with a delivery port of the first hydraulic pump 20a. The resultant configuration is a tandem circuit that prioritizes the track right directional control valve 12a and a parallel circuit with the remaining bucket directional control valve 15a, arm second directional control valve 14a, and boom first directional control valve 13a.

The boom second directional control valve 13b, the arm first directional control valve 14b, and the track left directional control valve 12b are disposed in the second pump line 21b that communicates with a delivery port of the second hydraulic pump 20b. The resultant configuration is a parallel circuit with the boom second directional control valve 13b and the arm first directional control valve 14b and a parallel-tandem circuit with the track left directional control valve 12b. A check valve 17 that permits inflow only from the second hydraulic pump 20b side and a restrictor 18 are disposed in the parallel circuit with the track left directional control valve 12b. Additionally, the track left directional control valve 12b can communicate with the first hydraulic pump 20 via a track communication valve 19.

The arm third directional control valve 14c and the swing directional control valve 16c are disposed in the third pump line 21c that communicates with a delivery port of the third hydraulic pump 20c. The resultant configuration is a tandem circuit that prioritizes the swing directional control valve 16c.

It is noted that an outlet port of the boom first directional control valve 13a and an outlet port of the boom second directional control valve 13b communicate with the boom cylinders 6 via a merging passage not shown. An outlet port of the arm second directional control valve 14a, an outlet port of the arm first directional control valve 14b, and an outlet port of the arm third directional control valve communicate with the arm cylinder 7 via a merging passage not shown. Additionally, an outlet port of the bucket directional control valve 15a communicates with the bucket cylinder 5 and an outlet port of the swing directional control valve 16c communicates with the swing hydraulic motor 11.

Reference is made to FIG. 2. The first control lever 9a to a fourth control lever 9d are each provided with pilot valves not shown thereinside. The pilot valves generate pilot pressure corresponding to an operation amount in a tilting operation of each control lever. The pilot pressure resulting from each control lever operation is supplied to an operating section of each directional control valve.

The pilot lines indicated by broken lines BkC and BkD from the first control lever 9a are connected with an operating section of the bucket directional control valve 15a. A bucket crowding pilot pressure and a bucket dumping pilot pressure generated corresponding to the operation amount in the tilting operation of the control lever are thus supplied. Additionally, a pilot line indicated by broken lines BmD and BmU from the first control lever 9a are connected with respective operating sections of the boom first directional control valve 13a and the boom second directional control valve 13b. A boom raising pilot pressure and a boom lowering pilot pressure generated corresponding to the operation amount in the tilting operation of the control lever are thus supplied.

A pressure sensor 105 and a pressure sensor 106 are provided in the pilot lines indicated by the broken lines BkC and BkD. The pressure sensor 105 detects the bucket crowding pilot pressure. The pressure sensor 106 detects the bucket dumping pilot pressure. A pressure sensor 101 and a pressure sensor 102 are provided in the pilot lines indicated by the broken lines BmD and BmU. The pressure sensor 101 detects the boom raising pilot pressure. The pressure sensor 102 detects the boom lowering pilot pressure. The pressure sensors 101, 102, 105, and 106 are each an operation instruction detection section. Pressure signals detected by the pressure sensors 101, 102, 105, and 106 are applied to the controller 100.

Pilot lines indicated by broken lines AmC and AmD from the second control lever 9b are connected with respective operating sections of the arm first directional control valve 14b, the arm second directional control valve 14a, and the arm third directional control valve 14c. An arm crowding pilot pressure and an arm dumping pilot pressure generated corresponding to the operation amount in the tilting operation of the control lever are thus supplied. Additionally, Pilot lines indicated by broken lines SwR and SwL from the second control lever 9b are connected with an operating section of the swing directional control valve 16c. A swing right pilot pressure and a swing left pilot pressure generated corresponding to the operation amount in the tilting operation of the control lever are thus supplied.

A pressure sensor 103 and a pressure sensor 104 are provided in the pilot lines indicated by the broken lines AmC and AmD. The pressure sensor 103 detects the arm crowding pilot pressure. The pressure sensor 104 detects the arm dumping pilot pressure. Additionally, an arm 3 crowding pressure reducing valve 22 is provided in an arm crowding pilot line connected with the operating section of the arm third directional control valve 14c. The arm 3 crowding pressure reducing valve 22 limits or interrupts an arm crowding pilot hydraulic fluid to be supplied.

A pressure sensor 108 and a pressure sensor 107 are provided in the pilot lines indicated by the broken lines SwR and SwL. The pressure sensor 108 detects the swing right pilot pressure. The pressure sensor 107 detects the swing left pilot pressure. The pressure sensors 103, 104, 107, and 108 are each an operation instruction detection section. Pressure signals detected by the pressure sensors 103, 104, 107, and 108 are applied to the controller 100.

Pilot lines indicated by broken lines TrRF and TrRR from the third control lever 9c are connected with an operating section of the track right directional control valve 12a. A track right forward pilot pressure and a track right reverse pilot pressure generated corresponding to the operation amount in the tilting operation of the control lever are thus supplied.

Pilot lines indicated by broken lines TrLF and TrLR from the fourth control lever 9d are connected with an operating section of the track left directional control valve 12b. A track left forward pilot pressure and a track left reverse pilot pressure generated corresponding to the operation amount in the tilting operation of the control lever are thus supplied.

The hydraulic control system in the present embodiment includes the controller 100. The controller 100 receives an input of the engine speed from the speed sensor 2Ax shown in FIG. 1 and receives inputs of pilot line pilot pressure signals from the respective pressure sensors 101 to 108 described above. Additionally, the controller 100 receives inputs of actuator pressure signals from the respective pressure sensors A6 to A8, B6 to B8, A11, and B11 shown in FIG. 1.

The controller 100 outputs command signals to the regulator 20d of the first hydraulic pump 20a, the regulator 20e of the second hydraulic pump 20b, and the regulator 20f of the third hydraulic pump 20c, respectively, to thereby control delivery flow rates to the respective hydraulic pumps 20a to 20c. The controller 100 also outputs a command signal to an operating section of the arm 3 crowding pressure reducing valve 22 to thereby control to limit or interrupt pressure of an arm crowding pilot line Amc to be supplied to the operating section of the arm third directional control valve 14c. An increase in the command signal interrupts the pilot pressure supplied to the operating section of the arm third directional control valve 14c. As a result, communication between the third hydraulic pump 20c and the arm cylinder 7 is interrupted and the hydraulic fluid from the third pump line 21c is returned to the tank.

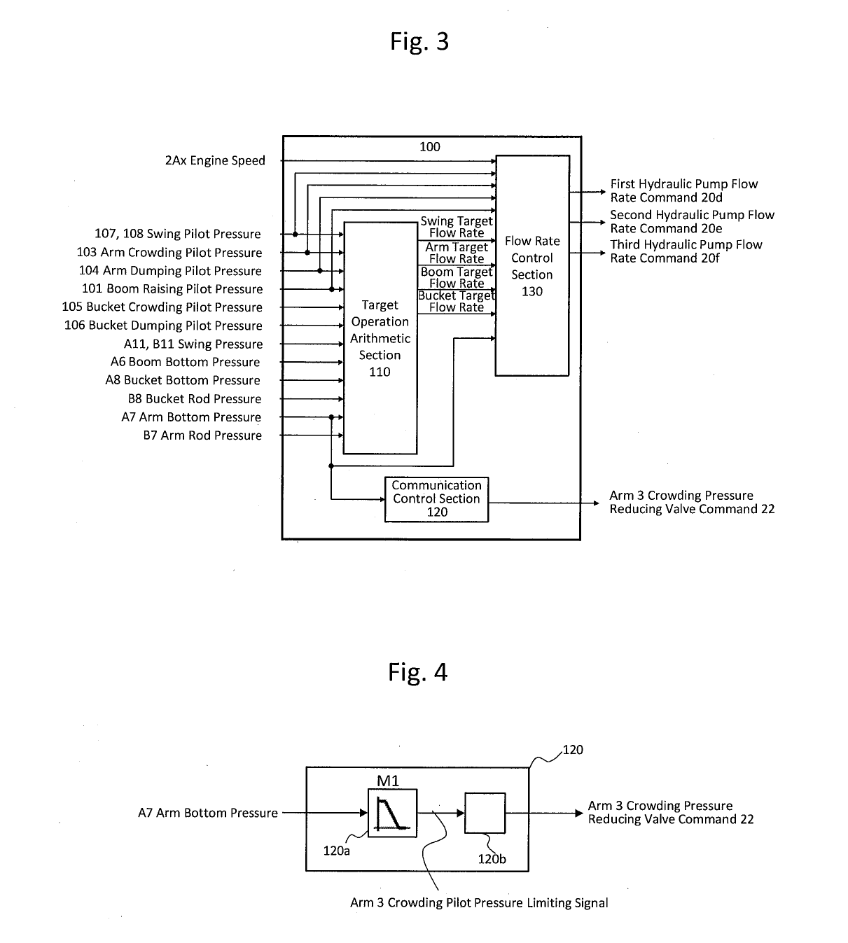

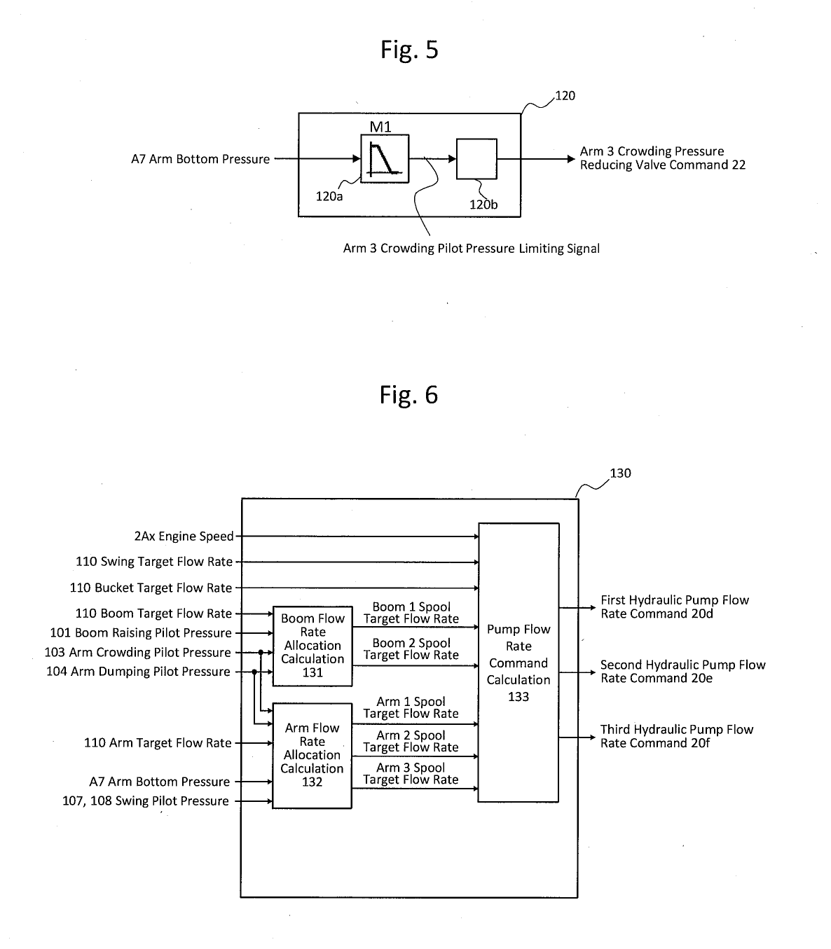

The controller that constitutes the hydraulic control system for a work machine according to the first embodiment is described below with reference to relevant drawings. FIG. 3 is a conceptual diagram of a configuration of the controller that constitutes the hydraulic control system for a work machine according to the first embodiment. FIG. 4 is a characteristic diagram representing an exemplary map for use by a target operation arithmetic section of the controller that constitutes the hydraulic control system for a work machine according to the first embodiment. FIG. 5 is a control block diagram representing exemplary arithmetic operations performed by a communication control section of the controller that constitutes the hydraulic control system for a work machine according to the first embodiment.

Reference is made to FIG. 3. The controller 100 includes a target operation arithmetic section 110, a communication control section 120, and a flow rate control section 130. Specifically, the target operation arithmetic section 110 calculates a target flow rate using each pilot pressure and each load pressure. The communication control section 120 serves as a communication control section that calculates a command signal for the arm 3 crowding pressure reducing valve 22 for controlling a communication state of the control valve 10. The flow rate control section 130 serves as a pump flow rate control section that calculates, on the basis of the target flow rates calculated by the target operation arithmetic section 110 and the engine speed from the speed sensor 2Ax, flow rate command signals of the respective first to third hydraulic pumps 20a to 20c. The flow rate control section 130 outputs command signals to the respective regulators 20d to 20f of the respective hydraulic pumps to thereby control the delivery flow rates of the respective first to third hydraulic pumps 20a to 20c.

The target operation arithmetic section 110 calculates each target flow rate such that the target flow rate increases with an increasing pilot pressure applied thereto and such that the target flow rate decreases with an increasing load pressure applied thereto. During combined operation, each target flow rate is calculated so as to be smaller than during single operation.

Exemplary calculations performed by the target operation arithmetic section 110 are described with reference to FIG. 4 and expressions. The target operation arithmetic section 110 stores, for each actuator, a map used for calculating a reference flow rate from a pilot pressure and shown in FIG. 4. For example, a swing target flow rate Qsw is calculated from a swing pilot pressure that represents a value applicable when maximum values of the swing right pilot pressure and the swing left pilot pressure are selected. Similarly, an arm crowding reference flow rate Qamc0 is calculated from the arm crowding pilot pressure and a dumping reference flow rate Qamd0 is calculated from the arm dumping pilot pressure.

A boom raising reference flow rate Qbmu0 is calculated from the boom raising pilot pressure. A bucket crowding reference flow rate Qbkc0 is calculated from the bucket crowding pilot pressure and a bucket dumping reference flow rate Qbkd0 is calculated from the bucket dumping pilot pressure.

The target operation arithmetic section 110 calculates a boom target flow rate Qbm from the swing target flow rate Qsw using an arithmetic expression, Expression 1.

Expression 1

Q_{bm}=min(Q_{bm0},Q_{bmmax}−k_{swbm}·Q_{sw}) (1)

Where, the symbol Qbmmax denotes a boom flow rate upper limit value and is set to correspond with a maximum speed of boom raising. The symbol kswbm denotes a boom flow rate reduction coefficient and the boom target flow rate Qbm decreases with an increasing swing target flow rate Qsw. It is noted that, instead of using the boom flow rate reduction coefficient kswbm, a map that causes the boom flow rate upper limit value Qbmmax to decrease with an increasing swing target flow rate Qsw may be used.

The target operation arithmetic section 110 uses arithmetic expressions, Expression 2 and Expression 3, to calculate swing drive power Lsw and boom drive power Lbm.

Expression 2

L_{sw}=P_{sw}·Q_{sw} (2)

Expression 3

L_{bm}=P_{bmb}·Q_{bm} (3)

Where, the symbol Psw denotes a swing pressure and represents a value of the pressure on a meter-in side selected from among the swing left pressure and the swing right pressure detected by the pressure sensors A11 and B11. The symbol Pbmb denotes a boom bottom pressure and represents the pressure of the bottom-side fluid chamber of the boom cylinder 6 detected by the pressure sensor A6.

The target operation arithmetic section 110 uses arithmetic expressions, Expression 4 and Expression 5, to calculate a bucket drive power upper limit value Lbkmax and an arm drive power upper limit value Lammax.

Expression 4

L_{bk max}=k_{bk}(Lₘₐₓ−L_{sw}−L_{bm}) (4)

Expression 5

Lₐₘₘₐₓ=kₐₘ(Lₘₐₓ−L_{sw}−L_{bm}) (5)

Where, the symbol Lmax denotes a total drive power upper limit value of the system. The symbol kbk denotes a bucket drive power coefficient and the symbol kam denotes an arm drive power coefficient. The bucket drive power coefficient kbk and the arm drive power coefficient kam are calculated using a bucket crowding pilot pressure BkC, a bucket dumping pilot pressure BkD, an arm crowding pilot pressure AmC, an arm dumping pilot pressure AmD, and an arithmetic expression Expression 6.

Expression 6

k_{bk}:kₐₘ=max(BkC,BkD):max(AmC,AmD) (6)

The target operation arithmetic section 110 uses the bucket crowding reference flow rate Qbkc0, the bucket dumping reference flow rate Qbkd0, the bucket drive power upper limit Lbkmax, and an arithmetic expression Expression 7 to calculate a bucket target flow rate Qbk. Additionally, the target operation arithmetic section 110 uses the arm crowding reference flow rate Qamc0, the arm dumping reference flow rate Qamd0, the arm drive power upper limit Lammax, and an arithmetic expression Expression 8 to calculate an arm target flow rate Qam.

Expression 7

Q_{bk}=min(Q_{bkc0},Q_{bkd0},L_{bkmax}/P_{bk}) (7)

Expression 8

Qₐₘ=min(Q_{amc0},Q_{amd0},Lₐₘₘₐₓ/Pₐₘ) (8)

Where, the symbol Pbk denotes a value of the pressure on a meter-in side selected from among the bottom-side fluid chamber pressure and the rod-side fluid chamber pressure of the bucket cylinder 8 detected by the pressure sensors A8 and B8. The symbol Pam denotes a value of the pressure on a meter-in side selected from among the bottom-side fluid chamber pressure and the rod-side fluid chamber pressure of the arm cylinder 7 detected by the pressure sensors A7 and B7.

Exemplary calculations performed by the communication control section 120 are described below with reference to FIG. 5. The communication control section 120 includes a first function generating section 120a and a solenoid valve drive command converting section 120b.

As shown in FIG. 5, the first function generating section 120a receives an input of the bottom-side fluid chamber pressure of the arm cylinder 7 detected by the pressure sensor A7. The first function generating section 120a stores therein in advance as a map M1 a table that indicates a limiting characteristic of the arm 3 crowding pilot pressure with respect to the bottom-side fluid chamber pressure of the arm cylinder 7. The map M1 exhibits a characteristic that the arm 3 crowding pilot pressure decreases with an increasing bottom-side fluid chamber pressure of the arm cylinder 7. An arm 3 crowding pilot pressure limiting characteristic signal calculated by the first function generating section 120a is output to the solenoid valve drive command converting section 120b.

The solenoid valve drive command converting section 120b receives the input of the arm 3 crowding pilot pressure limiting characteristic signal from the first function generating section 120a and calculates a command signal for the arm 3 crowding pressure reducing valve 22 corresponding to the limiting characteristic signal. Specifically, an increase in the command signal for the arm 3 crowding pressure reducing valve 22 reduces and interrupts the pilot pressure supplied to the operating section of the arm third directional control valve 14c, so that the characteristic is such that an output signal increases with an increasing input signal. The command signal calculated by the solenoid valve drive command converting section 120b is output to the operating section of the arm 3 crowding pressure reducing valve 22.

Thus, the pilot pressure supplied to the operating section of the arm third directional control valve 14c is reduced more with higher bottom-side fluid chamber pressures of the arm cylinder 7.

It is here noted that, in the limiting characteristic of the arm 3 crowding pilot pressure, the value of pressure starting to decrease from a certain value in the bottom-side fluid chamber of the arm cylinder 7 is preferably set to be equal to or higher than a pump delivery pressure at which leakage loss of the hydraulic pump is likely to exceed friction loss of the hydraulic pump and is set on the basis of the loss characteristic of the hydraulic pump.

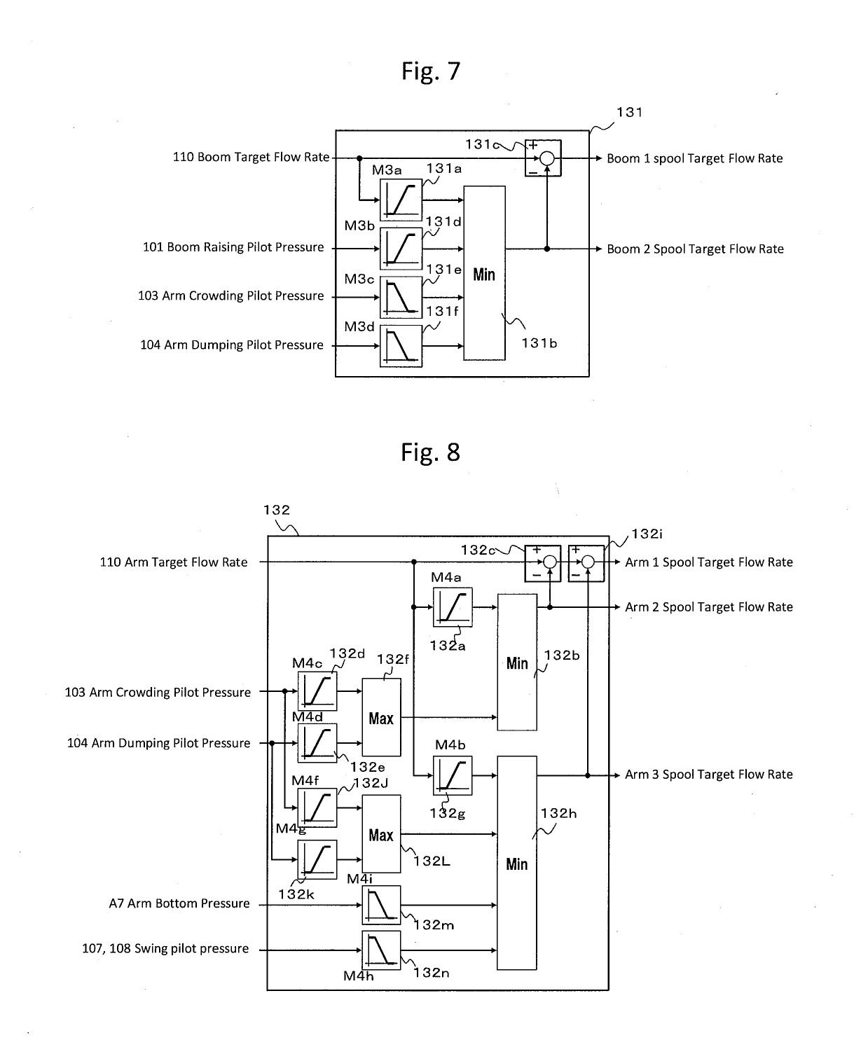

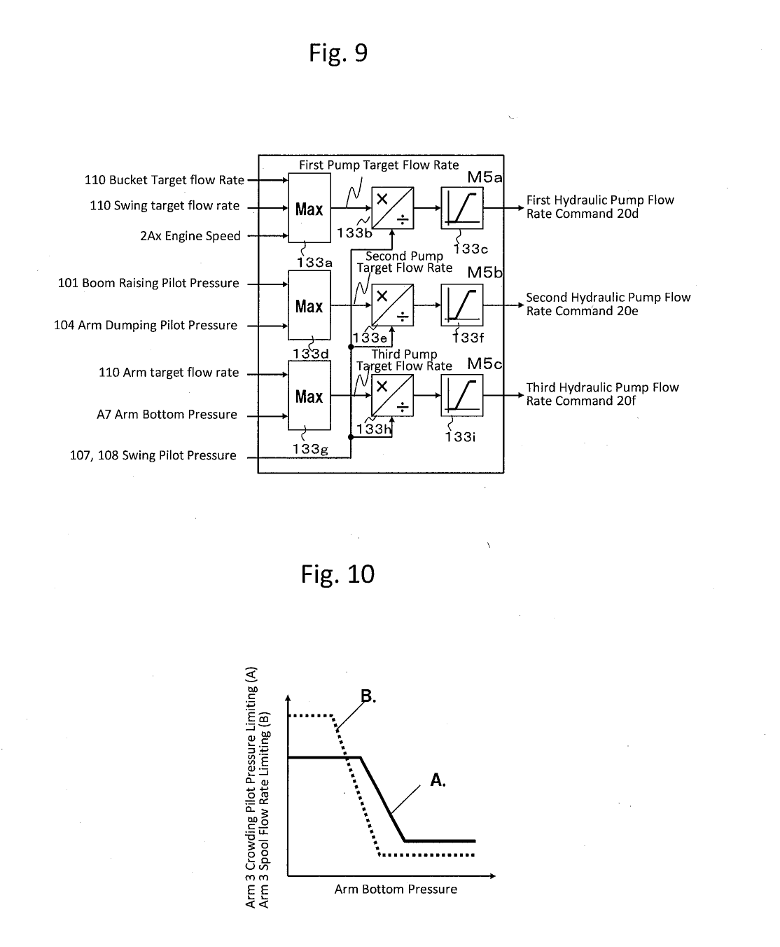

The flow rate control section 130 as a pump flow rate control section is described below with reference to relevant drawings. FIG. 6 is a conceptual diagram of a configuration of the flow rate control section of the controller that constitutes the hydraulic control system for a work machine according to the first embodiment. FIG. 7 is a control block diagram representing exemplary arithmetic operations performed by a boom flow rate allocation arithmetic section of the controller that constitutes the hydraulic control system for a work machine according to the first embodiment. FIG. 8 is a control block diagram representing exemplary arithmetic operations performed by an arm target flow rate allocation arithmetic section of the controller that constitutes the hydraulic control system for a work machine according to the first embodiment. FIG. 9 is a control block diagram representing exemplary arithmetic operations performed by a pump flow rate command arithmetic section of the controller that constitutes the hydraulic control system for a work machine according to the first embodiment. In FIGS. 6 to 9, like or corresponding elements are identified by the same reference numerals as those used in FIGS. 1 to 5 and descriptions for those elements are omitted.

Reference is made to FIG. 6. The flow rate control section 130 includes a boom flow rate allocation arithmetic section 131, an arm flow rate allocation arithmetic section 132, and a pump flow rate command arithmetic section 133. Specifically, the boom flow rate allocation arithmetic section 131 calculates an allocation of a target flow rate for each of the directional control valves of the boom 3. The arm flow rate allocation arithmetic section 132 calculates an allocation of a target flow rate for each of the directional control valves of the arm 4. The pump flow rate command arithmetic section 133 calculates the flow rate of each pump on the basis of the calculated target flow rate allocation and outputs command signals to the respective regulators 20d to 20f of the respective hydraulic pumps to thereby control the delivery flow rates of the respective first to third hydraulic pumps 20a to 20c.

Exemplary calculations performed by the boom flow rate allocation arithmetic section 131 are described below with reference to FIG. 7. The boom flow rate allocation arithmetic section 131 includes a first function generating section 131a, a minimum value selecting section 131b, a subtractor 131c, a second function generating section 131d, a third function generating section 131e, and a fourth function generating section 131f.

The first function generating section 131a receives an input of the boom target flow rate from the target operation arithmetic section 110. The first function generating section 131a stores therein in advance as a map M3a a table that indicates a boom 2 spool target flow rate with respect to the boom target flow rate. The map M3a exhibits a characteristic that the boom 2 spool target flow rate increases with an increasing boom target flow rate. The boom 2 spool target flow rate may be set, for example, to half of the boom target flow rate. In this case, a boom 1 spool target flow rate and the boom 2 spool target flow rate are each half of the boom target flow rate, unless the limiting to be described later is imposed. The calculated boom 2 spool target flow rate signal is output to the minimum value selecting section 131b.

The minimum value selecting section 131b receives inputs of the boom 2 spool target flow rate signal from the first function generating section 131a, a signal from the second function generating section 131d to be described later, a limiting signal from the third function generating section 131e to be described later, and a limiting signal from the fourth function generating section 131f to be described later. The minimum value selecting section 131b calculates a minimum value among these signals and outputs the minimum value as the boom 2 spool target flow rate to the subtractor 131c and the pump flow rate command arithmetic section 133.

The subtractor 131c receives inputs of the boom target flow rate from the target operation arithmetic section 110 and the boom 2 spool target flow rate from the minimum value selecting section 131b. The subtractor 131c then subtracts the boom 2 spool target flow rate from the boom target flow rate to thereby find the boom 1 spool target flow rate. The subtractor 131c outputs the calculated boom 1 spool target flow rate signal to the pump flow rate command arithmetic section 133.

The second function generating section 131d receives an input of the boom raising pilot pressure detected by the pressure sensor 101 and outputs a limiting signal to the minimum value selecting section 131b. The second function generating section 131d stores therein in advance as a map M3b a table that indicates an upper limit value of the boom 2 spool target flow rate with respect to the boom raising pilot pressure. The map M3b exhibits a trend of substantially proportional to a meter-in opening characteristic of the boom second directional control valve 13b, increasing with the boom raising pilot pressure. Specifically, the second function generating section 131d increases the upper limit value of the boom 2 spool target flow rate corresponding to the opening in the boom second directional control valve 13c.

The third function generating section 131e receives an input of the arm crowding pilot pressure detected by the pressure sensor 103 and outputs to the minimum value selecting section 131b a signal obtained from a map M3c stored in advance as a table. The map M3c exhibits a trend of substantially proportional to a meter-in opening characteristic of the arm first directional control valve 14b with respect to the arm crowding pilot pressure, reducing the upper limit of the boom 2 spool flow rate corresponding to the arm crowding pilot pressure.

The fourth function generating section 131f receives an input of the arm dumping pilot pressure detected by the pressure sensor 104 and outputs to the minimum value selecting section 131b a signal obtained from a map M3d stored in advance as a table. The map M3d exhibits a trend of substantially proportional to a meter-in opening characteristic of the arm first directional control valve 14b with respect to the arm dumping pilot pressure, reducing the upper limit value of the boom 2 spool flow rate corresponding to the arm dumping pilot pressure.

The boom flow rate allocation arithmetic section 131 limits the boom 2 spool target flow rate using these boom 2 spool flow rate upper limit values and subtracts the boom 2 spool target flow rate from the boom target flow rate to find the boom 1 spool target flow rate.

Exemplary calculations performed by the arm flow rate allocation arithmetic section 132 are described below with reference to FIG. 8. The arm flow rate allocation arithmetic section 132 includes a first function generating section 132a, a first minimum value selecting section 132b, a first subtractor 132c, a second function generating section 132d, a third function generating section 132e, a first maximum value selecting section 132f, a fourth function generating section 132g, a second minimum value selecting section 132h, a second subtractor 132i, a fifth function generating section 132J, a sixth function generating section 132k, a second maximum value selecting section 132L, a seventh function generating section 132m, and an eighth function generating section 132n.

The first function generating section 132a and the fourth function generating section 132g each receive an input of the arm target flow rate from the target operation arithmetic section 110. The first function generating section 132a stores therein in advance as a map M4a a table that indicates an arm 2 spool target flow rate with respect to the arm target flow rate. The fourth function generating section 132g stores therein in advance as a map M4b a table that indicates an arm 3 spool target flow rate with respect to the arm target flow rate. The maps M4a and M4b each exhibit a characteristic that the arm 2 spool target flow rate and the arm 3 spool target flow rate increase with an increasing arm target flow rate. Here, for example, each of the arm 2 spool target flow rate and the arm 3 spool target flow rate may be set to ⅓ of the arm target flow rate. In this case, the arm 1 spool target flow rate, the arm 2 spool target flow rate, and the arm 3 spool target flow rate are each ⅓ of the arm target flow rate, unless the limiting to be described later is imposed. The calculated arm 2 spool target flow rate signal is output to the first minimum value selecting section 132b. The calculated arm 3 spool target flow rate signal is output to the second minimum value selecting section 132h.

The first minimum value selecting section 132b receives inputs of the arm 2 spool target flow rate signal from the first function generating section 132a and a limiting signal from the first maximum value selecting section 132f to be described later. The first minimum value selecting section 132b calculates a minimum value of these signals and outputs the minimum value as an arm 2 spool target flow rate signal to the first subtractor 132c and the pump flow rate command arithmetic section 133.

The first subtractor 132c receives inputs of the arm target flow rate from the target operation arithmetic section 110 and the arm 2 spool target flow rate from the first minimum value selecting section 132b. The first subtractor 132c subtracts the arm 2 spool target flow rate from the arm target flow rate to thereby find an arm 1 spool target flow rate reference signal. The calculated arm 1 spool target flow rate reference signal is output to the second subtractor 132i.

The second function generating section 132d receives an input of the arm crowding pilot pressure detected by the pressure sensor 103 and outputs to the first maximum value selecting section 132f a signal obtained from a map M4c stored in advance as a table. The map M4c exhibits a trend of substantially proportional to a meter-in opening characteristic of the arm second directional control valve 14a with respect to the arm crowding pilot pressure, increasing the upper limit value of the arm 2 spool flow rate corresponding to the arm crowding pilot pressure.

The third function generating section 132e receives an input of the arm dumping pilot pressure detected by the pressure sensor 104 and outputs to the first maximum value selecting section 132f a signal obtained from a map M4d stored in advance as a table. The map M4d exhibits a trend of substantially proportional to a meter-in opening characteristic of the arm second directional control valve 14a with respect to the arm dumping pilot pressure, increasing the upper limit value of the arm 2 spool flow rate corresponding to the arm dumping pilot pressure.

The first maximum value selecting section 132f receives inputs of an output from the second function generating section 132d and an output from the third function generating section 132e. The first maximum value selecting section 132f calculates a maximum value of these outputs and outputs the maximum value to the first minimum value selecting section 132b.

The second minimum value selecting section 132h receives inputs of an arm 3 spool target flow rate signal from the fourth function generating section 132g, a limiting signal from the second maximum value selecting section 132L to be described later, and limiting signals from the seventh function generating section 132m and the eighth function generating section 132n. The second minimum value selecting section 132h calculates a minimum value of these signals and outputs the minimum value as an arm 3 spool target flow rate signal to the second subtractor 132i and the pump flow rate command arithmetic section 133.

The second subtractor 132i receives inputs of the arm 1 spool target flow rate reference signal calculated by the first subtractor 132c and the arm 3 spool target flow rate from the second minimum value selecting section 132h. The second subtractor 132i subtracts the arm 3 spool target flow rate from the arm 1 spool target flow rate reference signal to thereby calculate the arm 1 spool target flow rate reference signal. The calculated arm 1 spool target flow rate signal is output to the pump flow rate command arithmetic section 133.

The fifth function generating section 132J receives an input of the arm crowding pilot pressure detected by the pressure sensor 103 and outputs to the second maximum value selecting section 132L a signal obtained from a map M4f stored in advance as a table. The map M4f exhibits a trend of substantially proportional to a meter-in opening characteristic of the arm third directional control valve 14c with respect to the arm crowding pilot pressure, increasing the upper limit value of the arm 3 spool flow rate corresponding to the arm crowding pilot pressure. It is noted that, as compared with the characteristic of the map M4c, the characteristic of the map M4f is such that the output rises with a higher input value (arm crowding pilot pressure). This arrangement results in the following. Specifically, when the operation amount of the second control lever 9b that operates the arm 4 is small, the arm 2 spool target flow rate signal is first generated and, after the operation amount of the second control lever 9b that operates the arm 4 increases, the arm 3 spool target flow rate signal is generated.

The sixth function generating section 132k receives an input of the arm dumping pilot pressure detected by the pressure sensor 104 and outputs to the second maximum value selecting section 132L a signal obtained from a map M4g stored in advance as a table. The map M4g exhibits a trend of substantially proportional to a meter-in opening characteristic of the arm third directional control valve 14c with respect to the arm dumping pilot pressure, increasing the upper limit value of the arm 3 spool flow rate corresponding to the arm dumping pilot pressure. It is noted that, as compared with the characteristic of the map M4d, the characteristic of the map M4g is such that the output rises with a higher input value (arm dumping pilot pressure). This arrangement results in the following. Specifically, when the operation amount of the second control lever 9b that operates the arm 4 is small, the arm 2 spool target flow rate signal is first generated and, after the operation amount of the second control lever 9b increases, the arm 3 spool target flow rate signal is generated.

The second maximum value selecting section 132L receives inputs of an output from the fifth function generating section 132J and an output from the sixth function generating section 132k. The second maximum value selecting section 132L calculates a maximum value of these outputs and outputs the maximum value to the second minimum value selecting section 132h.

The seventh function generating section 132m receives an input of the bottom-side fluid chamber pressure of the arm cylinder 7 detected by the pressure sensor A7 and outputs to the second minimum value selecting section 132h a signal obtained from a map M4i stored in advance as a table. The map M4i is set, as is described later, such that the arm 3 spool flow rate upper limit value decreases corresponding to the bottom-side fluid chamber pressure of the arm cylinder 7.

The eighth function generating section 132b receives an input of a maximum value out of the swing right pilot pressure and the swing left pilot pressure detected by the pressure sensors 108 and 107, respectively, and outputs to the second minimum value selecting section 132h a signal obtained from a map M4h stored in advance as a table. The map M4h exhibits a trend of substantially proportional to a center bypass opening characteristic of the swing directional control valve 16c with respect to the swing pilot pressure, decreasing the upper limit value of the arm 3 spool flow rate corresponding to the swing pilot pressure.

The arm flow rate allocation arithmetic section 132 calculates the arm 1 spool target flow rate, the arm 2 spool target flow rate, and the arm 3 spool target flow rate on the basis of, for example, the arm target flow rate, the arm crowding pilot pressure, and the arm dumping pilot pressure calculated by the target operation arithmetic section 110. As described previously, however, because the rising point of the output with respect to the input is varied between the map M4c of the second function generating section 132d and the map M4f of the fifth function generating section 132J, and between the map M4d of the third function generating section 132e and the map M4g of the sixth function generating section 132k, the arm 1 spool target flow rate, the arm 2 spool target flow rate, and the arm 3 spool target flow rate are generated in sequence as the operation amount of the second control lever 9b that operates the arm 4 increases.

Thereafter, the arm 1 spool target flow rate and the arm 2 spool target flow rate are generated to correspond to the operation amount of the second control lever 9b. When the operation amount further increases, the arm 3 spool target flow rate is generated.

Exemplary calculations performed by the pump flow rate command arithmetic section 133 are described below with reference to FIG. 9. The pump flow rate command arithmetic section 133 includes a first maximum value selecting section 133a, a first divider 133b, a first function generating section 133c, a second maximum value selecting section 133d, a second divider 133e, a second function generating section 133f, a third maximum value selecting section 133g, a third divider 133h, and a third function generating section 133i.

The first maximum value selecting section 133a receives inputs of a bucket target flow rate signal from the target operation arithmetic section 110, a boom 1 spool target flow rate signal from the boom flow rate allocation arithmetic section 131, and an arm 2 spool target flow rate signal from the arm flow rate allocation arithmetic section 132. The first maximum value selecting section 133a then calculates a maximum value of these signals and outputs the maximum value as a first pump target flow rate to the first divider 133b.

The first divider 133b receives inputs of the first pump target flow rate from the first maximum value selecting section 133a and the engine speed detected by the speed sensor 2Ax. The first divider 133b then divides the first pump target flow rate by the engine speed to find a first pump target command. The calculated first pump target command signal is output to the first function generating section 133c.

The first function generating section 133c receives an input of the first pump target command signal calculated by the first divider 133b. The first function generating section 133c outputs as a first pump flow rate command signal a signal obtained from a map M5a stored in advance as a table to the regulator 20d. The delivery flow rate of the first hydraulic pump 20a is thereby controlled.

The second maximum value selecting section 133d receives inputs of a boom 2 spool target flow rate signal from the boom flow rate allocation arithmetic section 131 and an arm 1 spool target flow rate signal from the arm flow rate allocation arithmetic section 132. The second maximum value selecting section 133d then calculates a maximum value of these signals and outputs the maximum value as a second pump target flow rate to the second divider 133e.

The second divider 133e receives inputs of the second pump target flow rate from the second maximum value selecting section 133d and the engine speed detected by the speed sensor 2Ax. The second divider 133e then divides the second pump target flow rate by the engine speed to find a second pump target command. The calculated second pump target command signal is output to the second function generating section 133f.

The second function generating section 133f receives an input of the second pump target command signal calculated by the second divider 133e. The second function generating section 133f outputs as a second pump flow rate command signal a signal obtained from a map M5b stored in advance as a table to the regulator 20e. The delivery flow rate of the second hydraulic pump 20b is thereby controlled.

The third maximum value selecting section 133g receives inputs of a swing target flow rate signal from the target operation arithmetic section 110 and an arm 3 spool target flow rate signal from the arm flow rate allocation arithmetic section 132. The third maximum value selecting section 133g then calculates a maximum value of these signals and outputs the maximum value as a third pump target flow rate to the third divider 133h.

The third divider 133h receives inputs of the third pump target flow rate from the third maximum value selecting section 133g and the engine speed detected by the speed sensor 2Ax. The third divider 133h then divides the third pump target flow rate by the engine speed to find a third pump target command. The calculated third pump target command signal is output to the third function generating section 133i.

The third function generating section 133i receives an input of the third pump target command signal calculated by the third divider 133b. The third function generating section 133i outputs as a third pump flow rate command signal a signal obtained from a map M5c stored in advance as a table to the regulator 20f. The delivery flow rate of the third hydraulic pump 20c is thereby controlled.

In the pump flow rate command arithmetic section 133, the arm 2 spool target flow rate is input to the first maximum value selecting section 133a, the arm 1 spool target flow rate is input to the second maximum value selecting section 133d, and the arm 3 spool target flow rate is input to the third maximum value selecting section 133g, and the first pump target flow rate, the second pump target flow rate, and the third pump target flow rate are calculated, respectively. It is here noted that, in the arm flow rate allocation arithmetic section 132, as described previously, the arm 1 spool target flow rate is first generated, the arm 2 spool target flow rate is next generated, and the arm 3 spool target flow rate is finally generated corresponding to the increase in the operation amount of the second control lever 9b that operates the arm 4.

This results in the following when the second control lever 9b that operates the arm 4 is operated. Specifically, corresponding to the increase in the operation amount, the second pump flow rate command signal is first generated, the first pump flow rate command signal is next generated, and the third pump flow rate command signal is finally generated.

It is noted that the present embodiment has been described for a case in which a reduction ratio involved from the engine 2A to each hydraulic pump is 1. For any reduction ratio other than 1, calculations need to be performed corresponding to the applicable reduction ratio.

The setting of the map of the seventh function generating section 132m of the arm flow rate allocation arithmetic section 132 is described below with reference to FIG. 10. FIG. 10 is a characteristic diagram representing an exemplary map for use by the arm flow rate allocation arithmetic section of the controller that constitutes the hydraulic control system for a work machine according to the first embodiment.

In FIG. 10, the abscissa represents pressure of the bottom-side fluid chamber pressure of the arm cylinder 7 and the ordinate represents target flow rate of the arm 3 spool. Additionally, a characteristic line A indicated by the solid line represents the arm 3 crowding pilot pressure limiting characteristic signal of the map M1 set for the first function generating section 120a of the communication control section 120. A characteristic line B indicated by the broken line represents the map M4i set for the seventh function generating section 132m, indicating an upper limit limiting characteristic of the arm 3 spool target flow rate with respect to the bottom-side fluid chamber pressure of the arm cylinder 7.

Reference is made to FIG. 10. The map M4i (characteristic line B) decreases the arm 3 spool target flow rate upper limit value with an increasing bottom-side fluid chamber pressure of the arm cylinder 7, so that the map M4i has an operating direction identical to an operating direction of the map M1 (characteristic line A) that decreases the arm 3 crowding pilot pressure limiting characteristic with an increasing bottom-side fluid chamber pressure of the arm cylinder 7. The map M4i (characteristic line B) is, however, set to exhibit a characteristic that the reduction in the arm 3 spool target flow rate upper limit starts before the characteristic line A starts decreasing (in a region of small bottom-side fluid chamber pressures of the arm cylinder 7).

This arrangement results in the following. Specifically, when the bottom-side fluid chamber pressure of the arm cylinder 7 starts increasing, the arm 3 spool flow rate upper limit first decreases and the delivery flow rate of the third hydraulic pump 20c decreases; thereafter, the limiting characteristic of the arm 3 crowding pilot pressure causes the arm 3 crowding pressure reducing valve 22 to operate, so that the center bypass opening of the arm third directional control valve 14c starts opening. Thus, before the center bypass opening of the arm third directional control valve 14c opens, the arm 3 spool flow rate upper limit decreases and the delivery flow rate of the third hydraulic pump 20c decreases. As a result, bleed-off loss that is generated in the arm third directional control valve 14c can be reduced. Additionally, a small change results in the meter-in flow rate to the arm cylinder 7 at the start of opening of the center bypass opening of the arm third directional control valve 14c, so that shock at this time can be reduced.

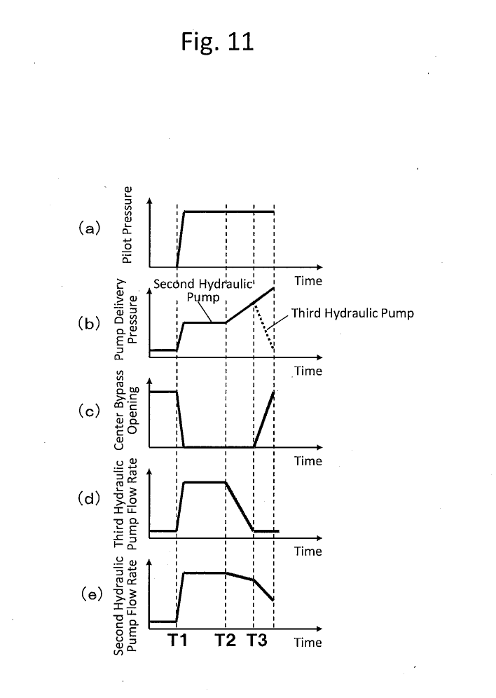

Operations of the hydraulic control system for a work machine according to the first embodiment of the present invention are described below with reference to relevant drawings. FIGS. 11(a) to 11(e) are characteristic diagrams illustrating exemplary operations relating to the pump flow rate control section in the hydraulic control system for a work machine according to the first embodiment.

In FIGS. 11(a) to 11(e), the abscissa represents time and the ordinate represents pilot pressure in FIG. 11(a), hydraulic pump delivery pressure in FIG. 11(b), arm third directional control valve 14c enter bypass opening in FIG. 11(c), third hydraulic pump delivery flow rate in FIG. 11(d), and fourth hydraulic pump delivery flow rate in FIG. 11(e), respectively. In FIG. 11(b), the solid line represents a delivery pressure characteristic of the second hydraulic pump 20b and the broken line represents a delivery pressure characteristic of the third hydraulic pump 20c. In addition, time T1 represents time at which an arm crowding operation is started, time T2 represents time at which the bottom-side fluid chamber pressure of the arm cylinder 7 increases because of, for example, the bucket contacting an excavation surface, and time T3 represents time at which the bottom-side fluid chamber pressure of the arm cylinder 7 further increases, respectively. It is noted that, for simplification purposes, operations of the first hydraulic pump 20a are omitted.

When the arm crowding operation is started at time T1, the arm crowding pilot pressure rises as shown in FIG. 11(a). The arm first directional control valve 14b and the arm third directional control valve 14c then operate, the arm cylinder 7 communicates with each hydraulic pump, and the pump delivery pressure shown in FIG. 11(b) rises to pressure corresponding to the bottom-side fluid chamber pressure of the arm cylinder 7. If the bottom-side fluid chamber pressure of the arm cylinder 7 is low at this time, the center bypass opening of the arm third directional control valve 14c closes as shown in FIG. 11(c). Additionally, as shown in FIGS. 11(d) and 11(e), the delivery flow rate of the third hydraulic pump 20c and the delivery flow rate of the second hydraulic pump 20b increase and the arm 4 operates.

When the bottom-side fluid chamber pressure of the arm cylinder 7 increases because of, for example, the bucket 5 contacting an excavation surface at time T2, the flow rate control section 130 reduces the delivery flow rate of the third hydraulic pump 20c as shown in FIG. 11(d). At this time, the arm flow rate allocation arithmetic section 132 considerably reduces the delivery flow rate of the second hydraulic pump 20b to correspond to the bottom-side fluid chamber pressure of the arm cylinder 7, so that a reduction amount in the delivery flow rate of the second hydraulic pump 20b is small as shown in FIG. 11(e) and a total arm meter-in flow rate is maintained at the arm target flow rate.

When the bottom-side fluid chamber pressure of the arm cylinder 7 further increases thereafter to reach, at time T3, a pressure value at which the pressure starts decreasing from a certain value due to the limiting characteristic of the arm 3 crowding pilot pressure in the communication control section 120, the center bypass opening of the arm third directional control valve 14c starts opening as shown in FIG. 11(c) and the delivery pressure of the third hydraulic pump 20c starts decreasing as shown in FIG. 11(b). It is noted that, preferably, the delivery flow rate of the third hydraulic pump 20c after time T3 shown in FIG. 11(d) is a standby flow rate. Operating the third hydraulic pump 20c with the standby flow rate improves an energy saving effect.

The standby flow rate, as used in the present embodiment, refers to a minimum delivery flow rate of the hydraulic fluid that needs to be delivered in order to protect the hydraulic pump to be operated.

In general, the leakage flow rate of the hydraulic pump increases substantially in proportion to the delivery pressure and the leakage flow rate has a greater effect on the loss of the hydraulic pump at higher delivery pressure values. Thus, under high load conditions, driving the arm cylinder 7 using only the second hydraulic pump 20b as in the hydraulic control system according to the present embodiment can minimize a total pump loss to thereby achieve energy saving, rather than driving the arm cylinder 7 using both the third hydraulic pump 20c and the second hydraulic pump 20b.

Additionally, the delivery flow rate of the third hydraulic pump 20c is reduced before the center bypass opening of the arm third directional control valve 14c starts opening. This reduces the bleed-off loss generated in the arm third directional control valve 14c.

Additionally, because of a small change in the meter-in flow rate to the arm cylinder 7 at the start of opening of the center bypass opening of the arm third directional control valve 14c, shock at this time can be reduced.

In the hydraulic control system for a work machine according to the first embodiment of the present invention described above, the delivery flow rate of the first hydraulic pump (third hydraulic pump 20c) decreases with an increasing load on the first hydraulic actuator (arm cylinder 7) and the first control valve (arm third directional control valve 14c) is driven to enlarge a communication area between the first hydraulic pump and the tank, so that the delivery pressure of the first hydraulic pump (third hydraulic pump 20c) can be reduced and the pump total leakage flow rate can be reduced. A void flow rate delivered from the first hydraulic pump (third hydraulic pump 20c) can thus be reduced. An energy-saving hydraulic control system for a work machine can thus be provided.

Additionally, in the hydraulic control system for a work machine according to the first embodiment of the present invention described above, the delivery flow rate of the first hydraulic pump (third hydraulic pump 20c) is reduced before the communication area between the first hydraulic pump (third hydraulic pump 20c) and the tank is enlarged corresponding to the load on the first hydraulic actuator (arm cylinder 7). This reduces the bleed-off loss generated in first control valve (arm third directional control valve 14c). Additionally, because of a small change in the meter-in flow rate to the first hydraulic actuator (arm cylinder 7) when the first control valve (arm third directional control valve 14c) is opened or closed, shock at this time can be reduced.

### Second Embodiment

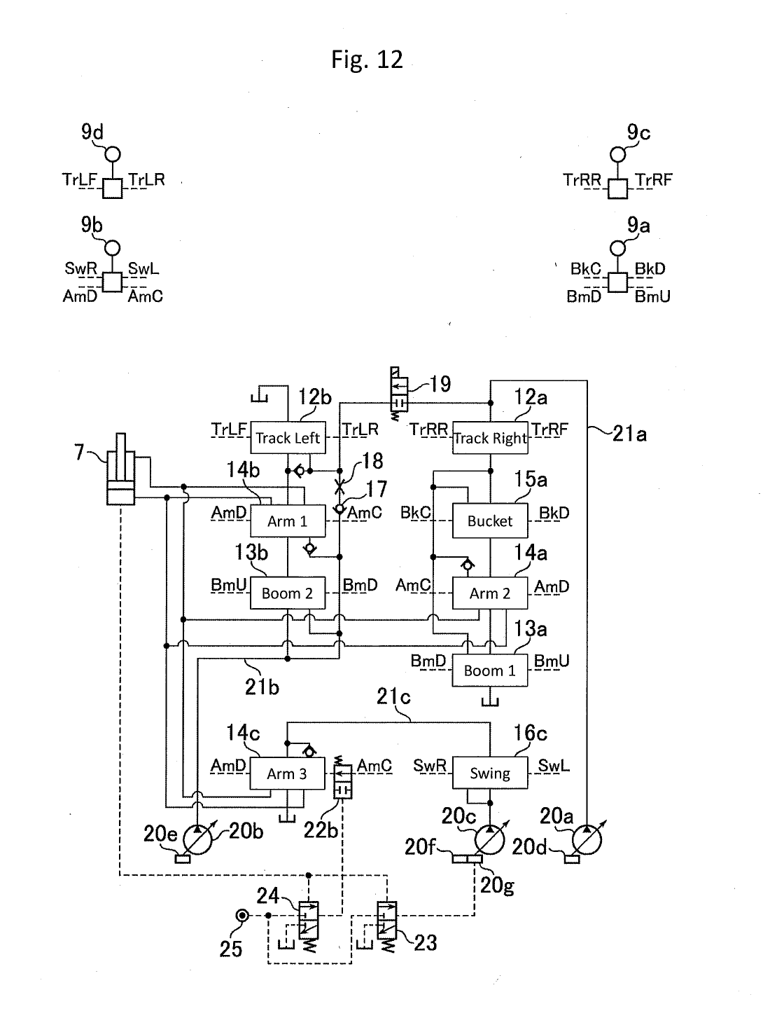

A hydraulic control system for a work machine according to a second embodiment of the present invention is described below with reference to a relevant drawing. FIG. 12 is a hydraulic control circuit diagram of the hydraulic control system for a work machine according to the second embodiment. In FIG. 12, like or corresponding elements are identified by the same reference numerals as those used in FIGS. 1 and 11(a) to 11(e) and descriptions for those elements will be omitted.

The hydraulic control system for a work machine according to the second embodiment of the present invention has a general system configuration substantially identical to a general system configuration of the hydraulic control system for a work machine according to the first embodiment. The hydraulic control system for a work machine according to the second embodiment differs from the hydraulic control system for a work machine according to the first embodiment in that the hydraulic control system in the second embodiment is configured to incorporate only a hydraulic circuit without the controller 100.

Specifically, as shown in FIG. 12, a regulator 20f of a third hydraulic pump 20c is operated by a sub-regulator 20g that is driven by pilot hydraulic pressure. A pilot hydraulic fluid is supplied to the sub-regulator 20g via a first selecting section valve 23 from a pilot hydraulic fluid source 25. To correspond to the supply of the hydraulic fluid to the sub-regulator 20g, the regulator 20f controls the delivery flow rate of the third hydraulic pump 20c in a decreasing direction.

The first selecting section valve 23 is a three-port two-position selecting section valve having a spring disposed on one side and receives a hydraulic fluid of a bottom-side fluid chamber of an arm cylinder 7 introduced to an operating section thereof. The first selecting section valve 23 has an inlet port connected with a hydraulic line from the pilot hydraulic fluid source 25 and an outlet port connected with a hydraulic line to the sub-regulator 20g. The first selecting section valve 23 has a drain port connected with a hydraulic line to a tank.

An arm 3 crowding pressure reducing valve 22b is provided in an arm crowding pilot line that is connected with an operating section of an arm third directional control valve 14c. The arm 3 crowding pressure reducing valve 22b limits or interrupts the arm crowding pilot hydraulic fluid to be supplied. The arm 3 crowding pressure reducing valve 22b is driven by the pilot hydraulic pressure. The pilot hydraulic fluid is supplied to the arm 3 crowding pressure reducing valve 22b via a second selecting section valve 24 from the pilot hydraulic fluid source 25. The arm 3 crowding pressure reducing valve 22b enlarges a communication area between the third hydraulic pump 20c and the tank so as to correspond to the supply of the hydraulic fluid to the arm 3 crowding pressure reducing valve 22b.

The second selecting section valve 24 is a three-port two-position selecting section valve having a spring disposed on one side and receives the hydraulic fluid of the bottom-side fluid chamber of the arm cylinder 7 introduced to an operating section thereof. The second selecting section valve 24 has an inlet port connected with a hydraulic line from the pilot hydraulic fluid source 25 and an outlet port connected with a hydraulic line to an operating section of the arm 3 crowding pressure reducing valve 22b. The second selecting section valve 24 has a drain port connected with a hydraulic line to the tank.

It is noted that, preferably, characteristics of the first selecting section valve 23 and the second selecting section valve 24 are adjusted such that the first selecting section valve 23 performs a changeover operation before the second selecting section valve 24 does so as to correspond to an increase in pressure of the hydraulic fluid of the bottom-side fluid chamber of the arm cylinder 7 introduced to the respective operating sections.

Additionally, in the present embodiment, a maximum value of control pilot pressures that drive directional control valves disposed in respective pump lines 21a, 21b, and 21c may be detected and the regulators 20d, 20e, and 20f may be driven on the basis of the detected value.

The hydraulic control system for a work machine according to the second embodiment of the present invention described above can achieve effects similar to those achieved by the hydraulic control system for a work machine according to the first embodiment.

It should be noted that the present invention is not limited to the above-described first and second embodiments and may include various modifications. The entire detailed configuration of the embodiments described above for ease of understanding of the present invention is not always necessary to embody the present invention. Part of the configuration of one embodiment may be replaced with the configuration of another embodiment, or the configuration of one embodiment may be added to the configuration of another embodiment. The configuration of each embodiment may additionally include another configuration, or part of the configuration may be deleted or replaced with another.

### DESCRIPTION OF REFERENCE NUMERALS

1: Lower track structure
2: Upper swing structure
2A: Engine
3: Boom
4: Arm
5: Bucket
6: Boom cylinder
7: Arm cylinder (first hydraulic actuator)
8: Bucket cylinder
9: Control lever (operating section)
10: Control valve
11: Swing hydraulic motor
13a: Boom first directional control valve
13b: Boom second directional control valve
14a: Arm second directional control valve
14b: Arm first directional control valve
14c: Arm third directional control valve (first control valve)
15a: Bucket directional control valve
16c: Swing directional control valve
20: Hydraulic pump system
20a: First hydraulic pump
20b: Second hydraulic pump (second hydraulic pump)
20c: Third hydraulic pump (first hydraulic pump)
20d: First hydraulic pump regulator
20e: Second hydraulic pump regulator
20f: Third hydraulic pump regulator
21a: First pump line
21b: Second pump line
21c: Third pump line
22: Arm 3 crowding pressure reducing valve (first control valve)
22b: Arm 3 crowding pressure reducing valve (first control valve)
23: First selecting section valve
24: Second selecting section valve
100: Controller
101 to 108: Pilot pressure sensor
110: Target operation arithmetic section
120: Communication control section (control valve drive section)
130: Flow rate control section (flow rate control section)
A7: Boom cylinder bottom-side fluid chamber pressure sensor (load detection section)

1. A hydraulic control system for a work machine including: a first hydraulic actuator; a first hydraulic pump and a second hydraulic pump capable of communicating with the first hydraulic actuator; a first control valve capable of returning a hydraulic fluid delivered by the first hydraulic pump to a tank; and a load detection section that detects a load on the first hydraulic actuator, the hydraulic control system comprising:
a control valve drive section that takes in a detection signal detected by the load detection section and drives the first control valve such that a communication area between the first hydraulic pump and the tank is enlarged corresponding to an increase in the load on the first hydraulic actuator; and
a flow rate control section that, during supply of the hydraulic fluid from the first hydraulic pump and the second hydraulic pump to the first hydraulic actuator, takes in a detection signal detected by the load detection section and controls to reduce a delivery flow rate of the first hydraulic pump corresponding to an increase in the load on the first hydraulic actuator.

2. The hydraulic control system for a work machine according to claim 1, wherein
the flow rate control section controls to reduce the delivery flow rate of the first hydraulic pump before the control valve drive section drives the first control valve such that the communication area between the first hydraulic pump and the tank is enlarged corresponding to an increase in the load on the first hydraulic actuator.

3. The hydraulic control system for a work machine according to claim 1, wherein
the flow rate control section is further capable of controlling to reduce a delivery flow rate of the second hydraulic pump, and
the flow rate control section controls to reduce the delivery flow rate of the first hydraulic pump before controlling to reduce the delivery flow rate of the second hydraulic pump corresponding to an increase in the load on the first hydraulic actuator.

4. The hydraulic control system for a work machine according to claim 1, further comprising:
a first operating section that instructs an operation of the first hydraulic actuator; and
an operation amount detection section that detects an operation amount of the first operating section, wherein
the flow rate control section takes in a detection signal detected by the operation amount detection section and, corresponding to an increase in the operation amount of the first operating section, increases the flow rate of the hydraulic fluid to be supplied from the second hydraulic pump to the first hydraulic actuator before increasing the flow rate of the hydraulic fluid to be supplied from the first hydraulic pump to the first hydraulic actuator.

5. The hydraulic control system for a work machine according to claim 1, wherein
the delivery flow rate of the first hydraulic pump after the reduction control is performed by the flow rate control section is a standby flow rate of the first hydraulic pump.
